(19) United States
(12) Patent Application Publication
(10) Pub. No.: US 2003/0117997 A1
(43) Pub. Date: Jun. 26, 2003

(54) Maintaining synchronization between a radio network controller and a base station

(75) Inventor: Young Hwan Kim, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/301,676

(22) Filed: Nov. 22, 2002

(30) Foreign Application Priority Data
Dec. 20, 2001 (KR) 81834/2001

(51) Int. Cl. H04J 3/06

(52) U.S. Cl. 370/350; 370/503

(57) ABSTRACT

Embodiments of the present invention relate to a method, which includes the following steps. Synchronizing a first device (i.e., a radio network controller) and a second device (i.e., a base station). Transmitting a first bundle of data (i.e., a frame) between the first device and the second device. Resynchronizing the first device and the second device if a predetermined amount of time has elapsed without a transmission of a bundle of data subsequent to the transmission of the first bundle of data. Embodiments of the present invention will resynchronize the first device and the second device if too much time has elapsed between that initial transmission of data between the first device and the second device. Accordingly, the present invention is advantageous as the synchronization of the first device and the second device can be maintained so that the effectiveness of the wireless communication system can be maintained over a longer period of time, rather than just after the initial synchronization.

### BACKGROUND OF THE INVENTION

1. Field of the Invention

The present invention generally relates to maintaining synchronization in a communication system.

2. Background of the Related Art

Mobile radio communication systems are used in everyday life. Garage door openers, remote controllers for home entertainment equipment, cordless telephones, hand-held walkie-talkies, pagers, and cellular telephones are all examples of mobile radio communication systems. Cellular radio systems provide high quality service that is often comparable to that of landline telephone systems. Over time, cellular radio systems have continued to evolve. In fact, third generation wireless networks (often referred to as 3G) are currently being developed. A goal of 3G wireless networks to for “cellular phones” to have both voice and data capabilities (such as internet browsing capabilities).

There are many components in a wireless communication system. Many of these components communicate with each other on a real-time basis. In other words, in a wireless communication system which services voice data (i.e., phone calls), it is necessary for the components of the wireless communication system to quickly communicate with each other so there is no noticeable lag in the transmission of data (i.e., a noticeable delay of sound in a telephone conversation). Accordingly, it is important for the components of the wireless communication system to be synchronized. In other words, it is important for the components of a wireless communication system to transmit and receive data at anticipated times. Synchronization of these components can be thought of using the analogy of a marching band which must march at the same beat in order to impress its audience. However, wireless communication systems often are unable to synchronize or are unable to maintain synchronization. As a result, data on the wireless communication system can be lost which decreases the effectiveness of the wireless communication system. Lost data, for example, may result in deterioration of the quality of sound in a telephone conversation that is being transmitted over the wireless communication system. Accordingly, there is a long felt need in wireless communication systems to maintain synchronization, so that the effectiveness of the wireless communication system is at a desirable level.

### SUMMARY OF THE INVENTION

An object of the present invention is to at least overcome the disadvantages of the related art. Embodiments of the present invention relate to a method, which includes the following steps. Synchronizing a first device (i.e., a radio network controller) and a second device (i.e., a base station). Transmitting a first bundle of data (i.e., a frame) between the first device and the second device. Resynchronizing the first device and the second device if a predetermined amount of time has elapsed without a transmission of a bundle of data subsequent to the transmission of the first bundle of data.

In other words, a first device and a second device are initially synchronized. After the synchronization, data is transmitted between the first device and the second device. Due to the in-demand aspect of wireless communication systems, some time may lapse between the initial transmission of data and a subsequent transmission of data. During this elapsed time, the first device and the second device may actually lose their synchronization. If the first device and the second device are not synchronized, then the subsequent transmission of data may be lost with undesirable consequences. Accordingly, embodiments of the present invention will resynchronize the first device and the second device if too much time has elapsed between that initial transmission of data between the first device and the second device. Accordingly, the present invention is advantageous as the synchronization of the first device and the second device can be maintained so that the effectiveness of the wireless communication system can be maintained over a longer period of time, rather than just after the initial synchronization.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

FIG. 1 is an exemplary block diagram schematically representing structure of an asynchronous mobile communication system.

FIG. 2a is an exemplary drawing representing a procedure for node synchronization.

FIG. 2b is an exemplary drawing representing a procedure for transport channel synchronization.

FIG. 3 is an exemplary flowchart representing a method for maintaining synchronization of a transport channel between a radio network controller (RNC) and a base station.

FIG. 4 is an exemplary flowchart representing a method for performing a procedure for node synchronization between a radio network controller (RNC) and a base station.

FIG. 5 is an exemplary flowchart representing a method for securing synchronization between a radio network controller (RNC) and a base station when transmission of a data frame is suspended for more than a predetermined period of time.

FIG. 6a is an exemplary drawing representing structure for an upward transport channel.

FIG. 6b is an exemplary drawing representing structure for a downward transport channel.

### DETAILED DESCRIPTION OF PREFERRED EMBODIMENTS

The W-CDMA (Wideband CDMA) system is a system for guaranteeing mobility and high quality voice services. W-CDMA adopts 32 kbps ADPCM (Adaptive Differential Pulse Code Modulation) for voice coding. Accordingly, W-CDMA may accomplish communication at a velocity of 100 km per hour. Further, W-CDMA is appropriate for transmission of lots of data because it uses band spreading. W-CDMA systems therefore have many application.

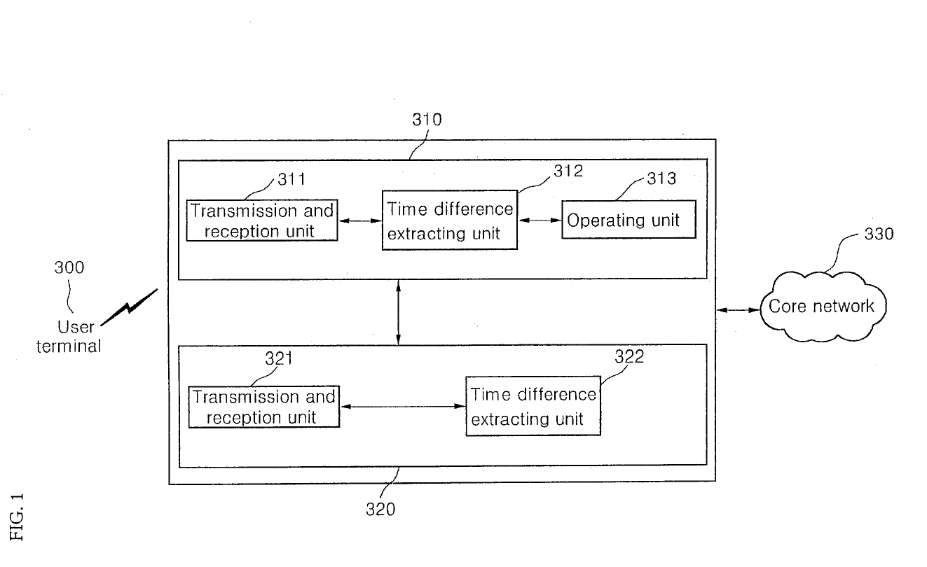

FIG. 1 exemplifies an asynchronous mobile communication system including a user terminal (UE) 300, a radio network controller (RNC) 310, a base station (node B) 320, and a core network (CN) 330. RNC 310 controls radio resources in its cells, playing a role to control a relevant cell. RNC 310 may include a transmission and reception unit 311, a time difference extracting unit 312, and an operating unit 313. Transmission and reception unit 311 may transmit a downward node synchronization message to base station 320 and may receive an upward node synchronization message transmitted from the base station 320 when a physical path between the RNC 310 and the base station 320 is established. Time difference extracting unit 312 may obtain a time difference between RNC 310 and base station 320, using time information. Time information may include transmission time for a downward node synchronization message by RNC 310, reception time for a downward node synchronization message when base station 320 receives a downward node synchronization message, transmission time for a Base Station Frame Number (BFN) when base station 320 transmits a BFN to RNC 310 in an upward node synchronization message.

Time difference extracting unit 312 may transfer an extracted time difference to operating unit 313. Time difference extracting unit 312 may, if there is a frame to be transmitted to base station 320, compare time of the frame that would be currently transmitted with time of a frame previously transmitted, obtaining a time difference. Time difference extracting unit 312, in case that the obtained time difference is greater than a predetermined time difference, puts a current Connection Frame Number (CFN) of RNC 310 on a controlling frame, transmitting the CFN to base station 320 through transmission and reception unit 311. Operating unit 313 may obtain a CFN using a time difference transferred from time difference extracting unit 312. Operating unit 313 may amend the CFN of the RNC 310 by a time difference between a CFN of base station 320 transmitted from base station 320 and a CFN of RNC 310.

Base station (node B) 320 is a logical node which may be responsible for radio transmission (or radio reception) to/from user terminal 300 from/to one or more cells. Base station 320 may include a transmission and reception unit 321 and/or a time difference extracting unit 322. Transmission and reception unit 321, after a physical path between the RNC 310 and the base station 320 is established, may receive a downward node synchronization message from the RNC 310. Transmission and reception unit 321 may transmit time information to RNC 310 on an upward node synchronization message. Time information may include at least one of transmission time for a downward node synchronization message, reception time for a downward node synchronization message when base station 320 receives the downward node synchronization message, and transmission time for a BFN. Time difference extracting unit 322 may obtain a time difference between a CFN transmitted from the RNC 310 and a CFN of the base station 320.

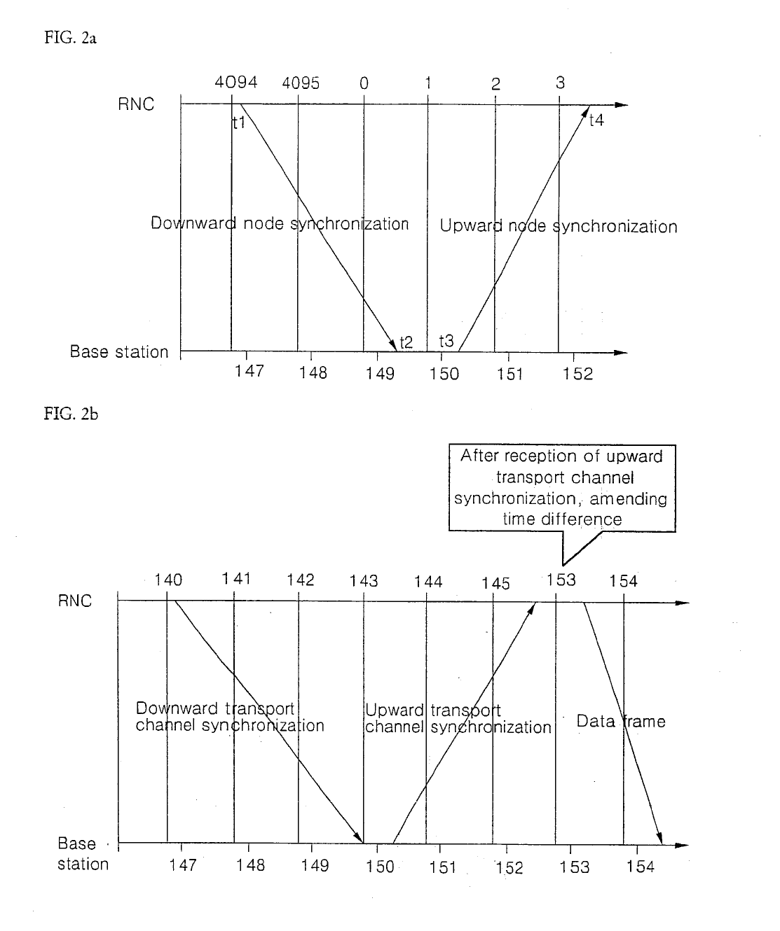

FIG. 2a is an exemplary drawing representing an exemplary procedure for node synchronization according to embodiments of the present invention. FIG. 2b is an exemplary drawing representing an exemplary procedure for transport channel synchronization according to embodiments of the present invention. A procedure for achieving synchronization of a transport channel between the radio network controller and a base station is described in an international standard (3GPP TS25.427: the dedicated transport channel, TS25.435: the common transport channel). In embodiments, achieving synchronization of a transport channel between a radio network controller and a base station may include a procedure for node synchronization that is carried out in advance.

In FIG. 2a and FIG. 2b, when a RNC transmits a downward node synchronization message including a RFN(t1) to a base station, the base station transmits an upward node synchronization message to the RNC including the RFN(t1) transmitted from the RNC, a BFN(t2) indicating when the base station receives the downward node synchronization message, transmission time information for BFN(t3). RFN represents a frame number of a RNC and BFN represents a frame number of a base station. RNC may obtain a time difference between the RNC and a base station using time information t1, t2, and t3 transmitted from the base station. The time difference may be a difference between t3 and t1 or may be RFN and a BFN. RNC may amend RFN by a time difference to obtain a CFN of a base station. For example, if the RFN value is 147 and the obtained time difference is 20 ms, the RNC amends the RFN by 149, a two-increment from 147. CFN may be a connection frame number for transport channel synchronization.

A formula for obtaining the CFN may be as follows:

CFN=(SFN−frame offset) mod 256=(BFN−frame offset) mod 256

SFN may be a frame number for a cell system, whose value may be the same as a BFN a time difference within 1 slot. A base station may obtain a SFN independently, for the SFN may be considered the same as a BFN. As a RNC may not know the SFN, the RNC may obtain the SFN through a procedure for node synchronization. For example, if a RFN of a RNC is 5 and a time difference between the RNC and a base station is 20 ms, the RFN of the RNC may be amended as 7 (a two-increment from 5) and the BFN may become 7. Frame offset is a radio link parameter and the frame offset of the same value may be given to a RNC and a base station.

FIG. 2b illustrates that RNC may verify a CFN obtained through a procedure for node synchronization by performing a procedure for transport channel synchronization. A RNC may transmit a CFN of a RNC to a base station. A base station may compare a CFN transmitted from a RNC with a CFN of the base station and determine whether a time difference between the CFN of the RNC and the CFN of the base station is within an allowed range of errors. If a time difference between a CFN of a RNC and a CFN of a base station is not within an allowed range of errors, the base station transmits the time difference to the RNC and the RNC may amend the CFN of the RNC by reflecting the time difference. If the time difference between a CFN of a RNC and a CFN of a base station is within an allowed range of errors, the RNC may transmit a data frame using the CFN.

Maintaining synchronization of transport channel is to make the CFNs of the RNC and the base station the same as each other at an arbitrary point in time. However, as time goes on, a CFN of a RNC and a CFN of a base station, whose synchronization was established with use of the procedure of node synchronization, become de-synchronized. In a circumstance that a CFN within a frame sent from a transmission side is beyond an allowed range (from the viewpoint of a reception side) and if the deviated range is more than the maximum range that could be communicated to a lower layer, then a relevant frame is thrown away without being communicated to the lower layer. A frame that is thrown away may be retransmitted according to a disposal procedure for a relevant frame, informed of from an upper layer, or remains thrown away. Even if retransmission is carried out, delay due to the retransmission is inevitable.

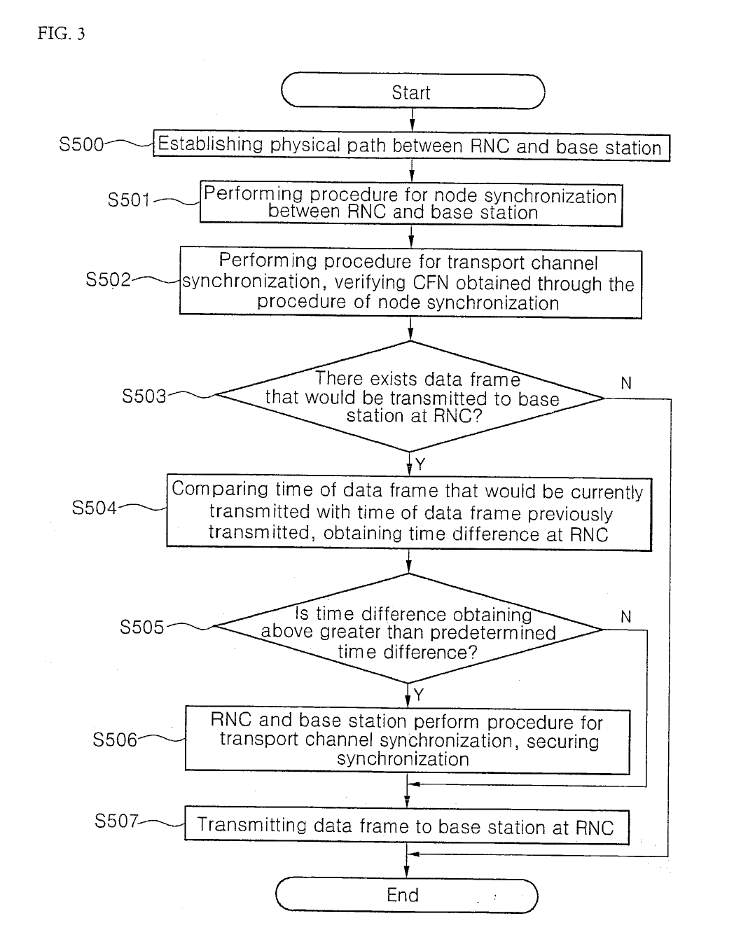

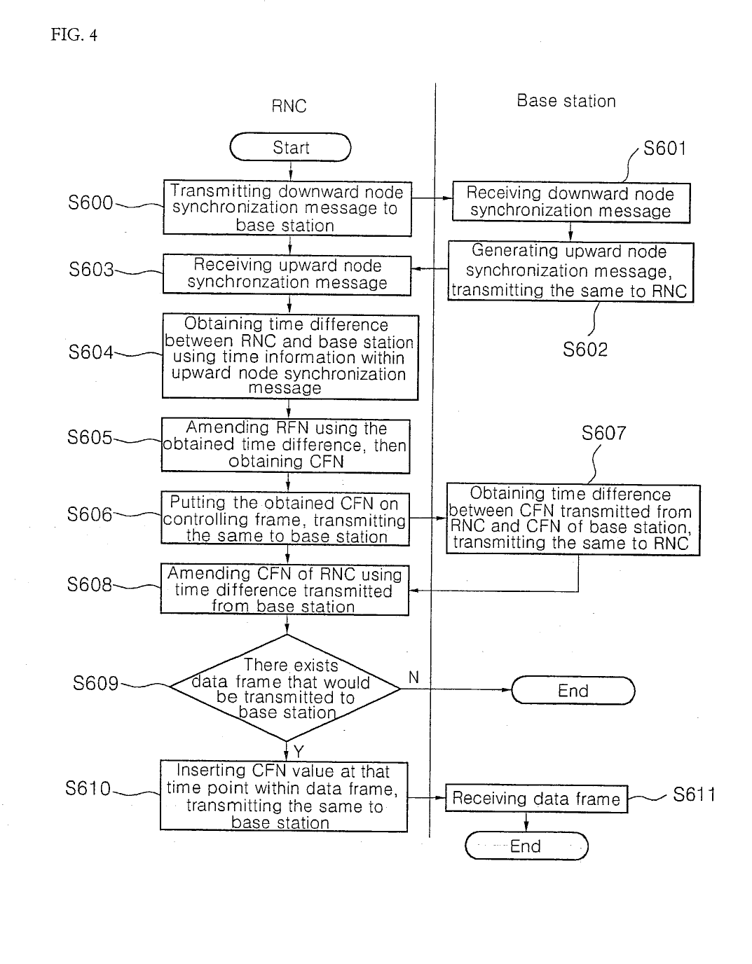

FIG. 3 is an exemplary flowchart representing a method for maintaining synchronization of a transport channel between a radio network controller (RNC) and a base station according to embodiments of the present invention. In FIG. 3, synchronization of a RNC and a base station is started when a layer responsible for management of radio resources of the RNC requests each relevant layer of the RNC and the base station for transport channel generation. When a physical path between a RNC and a base station is established (step S500), the RNC and the base station perform a procedure of node synchronization (step S501). An exemplary procedure of node synchronization is illustrated in FIG. 4. Performance of a procedure of node synchronization may result in establishment of node synchronization between a RNC and a base station. A RNC and a base station may then verify a CFN obtained through a procedure for node synchronization by performing a procedure for transport channel synchronization (step S502).

After step S502 is performed, if there exists a data frame that would be transmitted to a base station from a RNC (S503), the RNC may compare the time of a data frame previously transmitted with the time of a data frame that would be currently transmitted, obtaining time difference (step S504). If the time difference obtained above is greater than a predetermined time difference (step S505), a RNC and a base station perform a procedure for transport channel synchronization, securing synchronization between the RNC and the base station (step S506). A RNC may then transmit a relevant data frame to a lower layer (S507).

FIG. 4 is an exemplary flowchart representing a method for performing a procedure for node synchronization of a radio network controller (RNC) and a base station according to embodiments of the present invention. A RNC may transmit a downward node synchronization message including a RFN to a base station (step S600). A base station may receive a downward node synchronization message transmitted from a RNC (step S601). A base station may then transmit to an RNC an upward node synchronization message including a RFN of a downward node synchronization message, a BFN indicating when a downward node synchronization message was received, and/or transmission time information for the BFN (step S602). RNC may then receive an upward node synchronization message transmitted from a base station (step S603). The RNC may obtain a time difference between a RNC and a base station using time information included in a upward node synchronization message (step S604). Time information may include transmission time information for a RFN and transmission time information for a BFN. A RNC may amend a RFN using an obtained time difference and then may obtain a CFN (step S605). A RNC may include an obtained CFN on a controlling frame and transmit the controlling frame to the base station (step S606).

For example, a RFN is 145, transmission time for the RFN is 0 ms, reception time for a downward node synchronization message is 15 ms, and transmission time for a BFN is 20 ms. In this example, a time difference between the RNC and the base station is 20 ms, which is a time difference between the transmission time of the RFN and the transmission time of the BFN. In this example, it may be assumed that an RFN increases by 1 for every 10 ms. Under this assumption, the RNC amends the RFN from 145 to 147 using the time difference, making the BFN 147.

After step S606, a base station may obtain a time difference between a CFN transmitted from a RNC and a CFN of a base station and transmit this time difference to the RNC (step S607). A RNC may then amend a CFN using a transmitted time difference (step S608). A RNC may then continuously increase a CFN value by 1 for every 10 ms up to a maximum number (i.e., 255 or 4145) depending on the type of transport channel. If there exists a data frame that would be transmitted to a base station (step S609), a RNC may insert a CFN at that time point into a particular position within the data frame and may transmit the data frame to a base station (step S610). A base station may then receive a data frame transmitted from a RNC (step S611).

Although a RNC and a base station may be initially synchronized, time differences may be generated over time, as the RNC and the base station are separate systems. In a circumstance that data frames are continuously transmitted, amendment within an allowed time difference may be made continuously. However, in a circumstance that a data frame is suspended for more than a predetermined period of time and then transmitted again, a procedure for checking synchronization between a RNC and a base station before the RNC transmits a data frame may be required. In a circumstance that a time difference between a frame that is to be currently transmitted and a frame previously transmitted, is greater than a predetermined time difference, a procedure for determining whether transport channel synchronization should be performed can be tuned for the demands of a particular system.

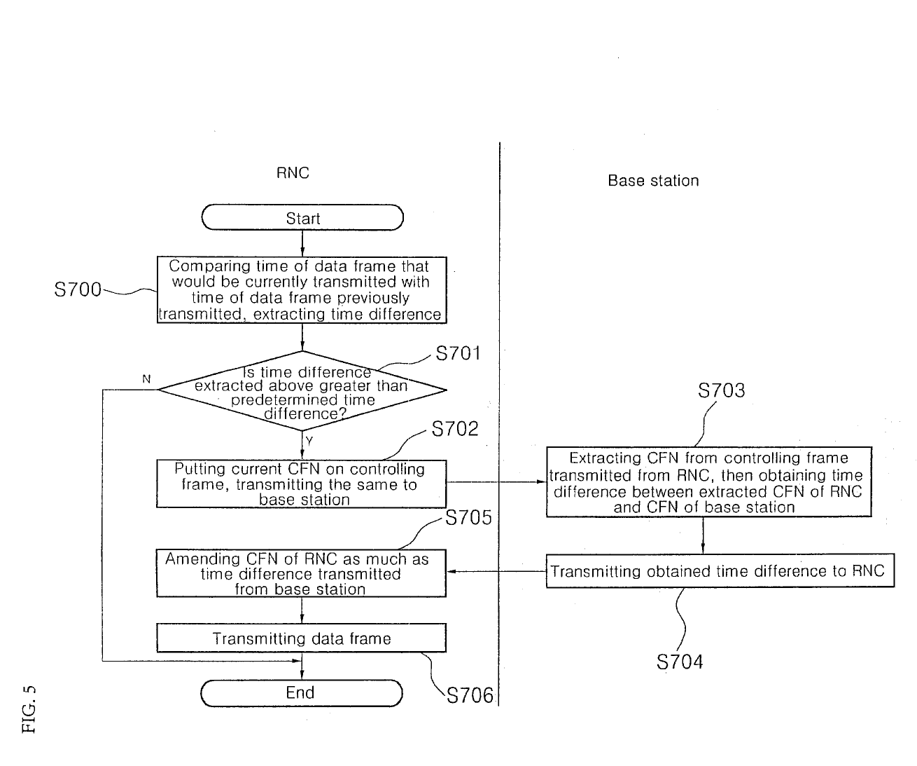

FIG. 5 is an exemplary flowchart in accordance with embodiments of the present invention representing a method for securing synchronization between a radio network controller (RNC) and a base station in a circumstance that transmission of a data frame is suspended for more than a predetermined period of time. A RNC may compare the time of a data frame previously transmitted with the time of a data frame that is to be currently transmitted, obtaining time difference (step S700).

If an obtained time difference is greater than a predetermined time difference, as a result of the step S700 (step S701), a RNC may put a current CFN on a controlling frame and transmit the controlling frame to a base station (step S702). A base station may extract a CFN from a controlling frame transmitted from a RNC to obtain a time difference between an extracted CFN of the RNC and a CFN of the base station (step S703). A base station may transmit an obtained time difference to an RNC (step S704). A RNC may then amend a CFN of the RNC by a time difference transmitted from a base station (step S705). A RNC may then transmit a data frame to a base station (step S706). Since synchronization between the RNC and the base station may be already secured through a procedure for transport channel synchronization before transmission of a data frame, a relevant data frame may be successfully communicated to a lower physical layer without being lost at a base station.

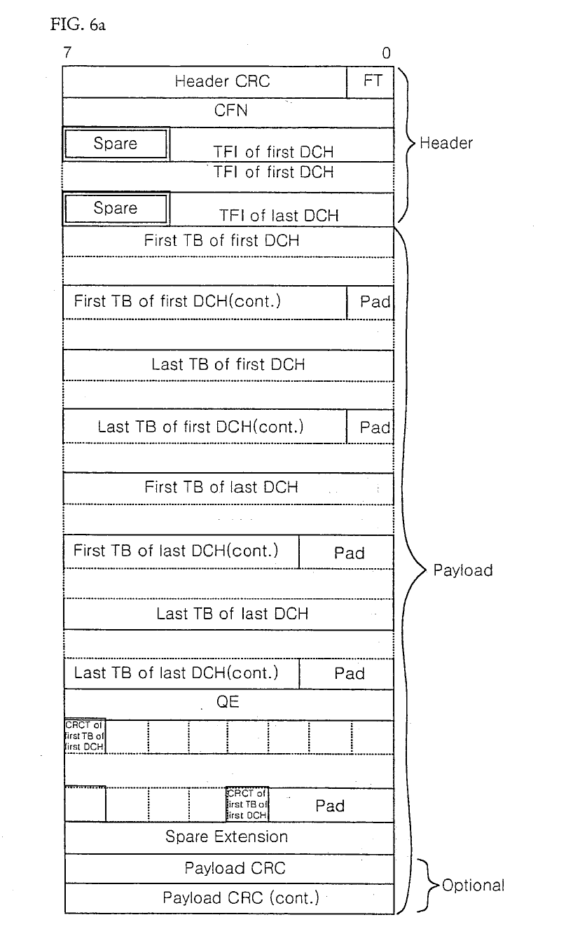

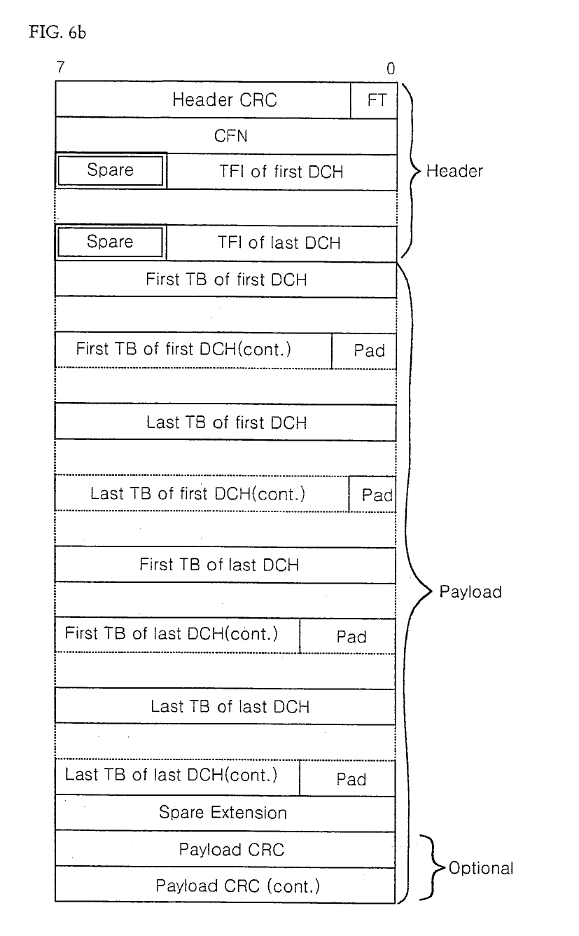

FIG. 6a is an exemplary drawing representing a structure for an upward transport channel according to embodiments of the present invention. FIG. 6b is an exemplary drawing representing a structure for a downward transport channel according to embodiments of the present invention. As shown, a CFN is inserted into a header within a controlling frame and transmitted.

Embodiments of the present invention relate to a method for maintaining synchronization of a transport channel between a radio network controller (RNC) and a base station. The method may comprise at least one of the following steps. Securing a first synchronization between the RNC and the base station. If there is a frame that would be transmitted to the base station, comparing, at the RNC, a first time of a frame that would be currently transmitted with a second time of a frame transmitted previously, and obtaining a time difference. If the obtained time difference is greater than the predetermined time difference, performing a second synchronization procedure.

In embodiments, the step of securing the first synchronization between the RNC and the base station may comprising at least one of the following steps. Establishing a physical path between the RNC and the base station. Obtaining a CFN (Connection Frame Number) by performing a procedure for node synchronization. Verifying the CFN obtained above by performing a procedure for transport channel synchronization.

In embodiments, obtaining the CFN may comprise at least one of the following steps. Transmitting, at the RNC, a node synchronization message to the base station. Transmitting, at the base station, a time information to the RNC by putting on a node synchronization message, the time information including transmission time for the node synchronization message of the RNC, reception time for the node synchronization message, transmission a time for a BFN (Base Station Frame Number). Obtaining, at the RNC, a CFN by obtaining the time difference between the RNC and the base station using the time information transmitted from the base station.

In embodiments, obtaining the CFN at the RNC may comprise at least one of the following steps. Obtaining, at the RNC, a time difference of the time information transmitted from the base station. Amending a RFN (Radio Network Controller Frame Number) of the RNC using the time difference obtained above. Obtaining a BFN using the amended RFN, then obtaining the CFN using the obtained BFN.

In embodiments, the time difference of the time information transmitted from the base station is a time difference between a first transmission time for the node synchronization message of the RNC and a second transmission time for the BFN of the base station. In embodiments, the CFN is obtained by an operation of a SFN (Cell System Frame Number) and a frame offset. In embodiments, the frame offset of same value is given to the RNC and the base station, respectively. In embodiments, the SFN is different from the BFN in the time, while the SFN value is same as the BFN. In embodiments, the first frame that would be currently transmitted and the second frame previously transmitted are performed for the procedure for the transport channel synchronization before a predetermined time difference.

In embodiments, the step of verifying the CFN may comprise at least one of the followings steps. Putting on a controlling frame, transmitting the current CFN of the RNC to the base station by putting on a controlling frame. Transmitting, at the base station, the time difference to the RNC by obtaining between the transmitted CFN of the RNC and the CFN of the base station. Amending, at the RNC, the CFN of the RNC as much as time the difference transmitted.

In embodiments, the second synchronization procedure may comprise the following steps. Transmitting a current CFN of the RNC to the base station by putting on a controlling frame. Obtaining, at the base station, the time difference between the transmitted CFN of the RNC and a CFN of the base station and transmitting to the RNC. Amending, at the RNC, the CFN of the RNC as much as the time difference transmitted, transmitting a data frame.

Embodiments relate to a method for maintaining synchronization of transport channel between a radio network controller (RNC) and a base station. The method may comprise at least one of the following steps. Transmitting, at the radio network controller (RNC), a node synchronization message to the base station when a physical path is established between the RNC and the base station. Transmitting, at the RNC, a time information to the RNC by putting on a node synchronization message, the time information including transmission time for the node synchronization message, reception time for the node synchronization message, transmission time for the BFN. Obtaining a CFN at the RNC by obtaining the time difference between the RNC and the base station using the time information transmitted from the base station. If there is a frame that would be transmitted to the base station, obtaining, at the RNC, the time difference by comparing a first time of a frame that would be currently transmitted with a second time of a frame previously transmitted. If the obtained time difference is greater than the predetermined time difference, transmitting the current CFN of the RNC to the base station by putting on a controlling frame. Obtaining, at the base station, the time difference between the transmitted CFN of the RNC and the CFN of the base station and transmitting to the RNC. Amending the CFN of the RNC as much as the time difference transmitted and transmitting a data frame at the RNC. In embodiments, the step of obtaining the CFN at the RNC further comprising the step of verifying an obtained CFN by performing a procedure for transport channel synchronization.

Embodiments relate to an apparatus for transmitting a data frame within a radio network controller (RNC) while maintaining a synchronization of the RNC and a base station. The apparatus may comprise at least one of the following. A means for transmitting a node synchronization message to the base station when a physical path is established between the RNC and the base station. A means for obtaining a time difference between the RNC and the base station using the time information of the node synchronization message transmitted from the base station. A means for obtaining a CFN using the time difference obtained above. A means for comparing a first time of the frame currently transmitted with a second time of a frame previously transmitted, if there being a frame that would be transmitted to the base station. A-means for transmitting t the current CFN of the RNC to the base station by putting on a controlling frame, if the obtained time difference is greater than the predetermined time difference. A means for amending the CFN of the RNC as much as time difference between the CFN of the base station transmitted from the base station and the CFN of the RNC.

Embodiments relate to an apparatus for transmitting a data frame within a base station while maintaining synchronization of a radio network controller (RNC) and a base station. The apparatus may comprise at least one of the following. A means for receiving a node synchronization message from the RNC when a physical path is established between the RNC and the base station. A means for transmitting a time information to the RNC by putting on a node synchronization message, the time information including transmission time for the node synchronization message, reception time for the node synchronization message, transmission time for the BFN. A means for obtaining the time difference between the transmitted CFN of the RNC and the CFN of the base station.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A method comprising:
synchronizing a first device and a second device;
transmitting a first bundle of data between the first device and the second device; and
resynchronizing the first device and the second device if a predetermined amount of time has elapsed without a transmission of a bundle of data subsequent to the transmission of the first bundle of data.

2. The method of claim 1, wherein at least one of the first device and the second device is a radio network controller.

3. The method of claim 1, wherein at least one of the first device and the second device is a base station.

4. The method of claim 1, wherein:
the first device is a radio network controller; and
the second device is a base station.

5. The method of claim 1, wherein at least one of the first device and the second device are components of a wireless communication network.

6. The method of claim 1, wherein a bundle of data is a frame.

7. The method of claim 1, wherein at least one of the synchronization and the resynchronization comprise:
establishing a physical path between the first device and the second device;
performing node synchronization between the first device and the second device; and
performing transport channel synchronization between the first device and the second device.

8. The method of claim 7, wherein the performing node synchronization comprises:
transmitting a first node synchronization message from the first device to the second device;
transmitting a second node synchronization message from the second device to the first device, wherein the second node synchronization message comprises timing information; and
adjusting timing of the first device according to the received timing information.

9. The method of claim 8, wherein the timing information comprises:
transmission time of the first node synchronization message from the first device;
reception time of the first node synchronization message at the second device; and
transmission time of the second node synchronization message.

10. The method of claim 8, wherein the adjusting timing of the first device is changing a connection flame number of the first device.

11. The method of claim 8, wherein the connection frame number is changed according to a frame number for a cell system and a frame offset.

12. An apparatus configured to:
synchronize a first device and a second device;
transmit a first bundle of data between the first device and the second device; and
resynchronize the first device and the second device if a predetermined amount of time has elapsed without a transmission of a bundle of data subsequent to the transmission of the first bundle of data.

13. The apparatus of claim 12, wherein at least one of the first device and the second device is a radio network controller.

14. The apparatus of claim 12, wherein at least one of the first device and the second device is a base station.

15. The apparatus of claim 12, wherein:
the first device is a radio network controller; and
the second device is a base station.

16. The apparatus of claim 12, wherein at least one of the first device and the second device are components of a wireless communication network.

17. The apparatus of claim 12, wherein a bundle of data is a frame.

18. The apparatus of claim 12, wherein at least one of the synchronization and the resynchronization comprise:
establishing a physical path between the first device and the second device;
performing node synchronization between the first device and the second device; and
performing transport channel synchronization between the first device and the second device.

19. The apparatus of claim 18, wherein the performing node synchronization comprises:
transmitting a first node synchronization message from the first device to the second device;
transmitting a second node synchronization message from the second device to the first device, wherein the second node synchronization message comprises timing information; and
adjusting timing of the first device according to the received timing information.

20. The apparatus of claim 19, wherein the timing information comprises:
transmission time of the first node synchronization message from the first device;
reception time of the first node synchronization message at the second device; and
transmission time of the second node synchronization message.

21. The apparatus of claim 19, wherein the adjusting timing of the first device is changing a connection frame number of the first device.

22. The apparatus of claim 19, wherein the connection frame number is changed according to a frame number for a cell system and a frame offset.

23. An apparatus comprising:
a radio network controller;
a base station; and
a means for maintaining synchronization between the radio network controller and the base station.
